(19) United States
(12) Patent Application Publication
(10) Pub. No.: US 2025/0279878 A1
(43) Pub. Date: Sep. 4, 2025

(54) MOVING BODY, ENCRYPTION KEY DELIVERY SYSTEM, ENCRYPTION KEY DELIVERY METHOD, AND PROGRAM

(71) Applicant: NEC Corporation, Minato- ku, Tokyo (JP)

(72) Inventor: Keisuke KANEYASU, Tokyo (JP)

(73) Assignee: NEC Corporation, Minato- ku, Tokyo (JP)

(21) Appl. No.: 18/859,647

(22) PCT Filed: May 26, 2022
(86) PCT No.: PCT/JP2022/021649

§ 371 Date: Oct. 24, 2024

(51) Int. Cl. H04L 9/08

(52) U.S. Cl. CPC H04L 9/0819; H04L 9/0852

(57) ABSTRACT

A moving body includes an input/output part that receives an encryption key from a transmission apparatus and transmits the encryption key to a reception apparatus; a storage control part that controls storage of the encryption key in a storage part; and a movement control part that moves the moving body to the reception apparatus after receiving the encryption key from the transmission apparatus, wherein the storage control part stores the encryption key in the storage part upon receiving the encryption key from the transmission apparatus and erases the encryption key stored in the storage part in a case where an abnormality is detected.

### TECHNICAL FIELD

The present disclosure relates to an encryption key delivery technology by a moving body.

### BACKGROUND ART

In the Internet, etc., there is a danger of data being wiretapped during transmission of information (data) from an apparatus on a transmission side to an apparatus on a reception side. To prevent this, there are various encryption technologies that conceal data being transmitted. In many encryption technologies, there is a method where data is encrypted with a key called an encryption key to be transmitted and then decrypted with the same encryption key on the reception side. Another method is to decrypt data using a decryption key corresponding to the encryption key, held in advance by the reception side. In the following, keys used for encryption and/or decryption of data, including a decryption key, are collectively referred to as encryption keys. Such encryption keys must be shared between the transmission side and the reception side before data transmission.

Generally, an encryption key is generated by one side and delivered to the other. Therefore, it is important to improve security during encryption key delivery.

There are various methods for encryption key delivery. For example, quantum cryptography (Quantum cryptography key delivery method) using quantum mechanics. (see, for example, Patent Literature (PTL) 1).

Quantum cryptography key delivery is a scheme to deliver securely an encryption key by communicating using quantum cryptography. However, a transmission line (transmission medium) is limited to an optical fiber or laser beams, and there are also distance limitations.

There is a technology that uses a flying body to deliver an encryption key without distance or transmission line restrictions (see, for example, PTL 2). In the technology disclosed in PTL 2, only part of the information necessary to generate the encryption key is temporarily held in the flying body. In other words, the encryption key is shared by a plurality of base stations without having all the information necessary to generate the encryption key in the flying body at the same time.

### CITATION LIST

### Patent Literature

[PTL 1] Japanese Unexamined Patent Publication No. 2017-055335 A

[PTL 2] Japanese Unexamined Patent Publication No. 2022-002379 A

### SUMMARY

### Technical Problem

The following analysis has been given by the inventor of the present application.

In the invention described in PTL 2, instead of the encryption key itself, a plurality of key information necessary to generate the encryption key is sequentially transmitted from the flying body to the plurality of base stations (transmission side and reception side). In the invention described in PTL 2, the encryption key itself is not transmitted from the flying body, so security during transmission and security on the flying body are not considered. The invention described in the PTL 2 is based on a premise that there is a transmission line using optical fiber, etc. between the transmission side and the reception side. The transmission line is used to transmit key information from either the transmission side or the reception side to the other side, and the key distillation process is performed by the side receiving thereof.

In view of the above-mentioned problems, it is an object of the present disclosure to provide a technique for delivering an encryption key safely, without requiring a transmission line between a transmission side and a reception side, and without distance and transmission line constraints.

### Solution to Problem

According to a first aspect of the present disclosure, there is provided a moving body including:
an input/output part that receives an encryption key from a transmission apparatus and transmits the encryption key to a reception apparatus;
a storage control part that controls storage of the encryption key in a storage part; and
a movement control part that moves the moving body to the reception apparatus after receiving the encryption key from the transmission apparatus, wherein
the storage control part stores the encryption key in the storage part upon receiving the encryption key from the transmission apparatus and erases the encryption key stored in the storage part in a case where an abnormality is detected.

According to a second aspect of the present disclosure, there is provided an encryption key delivery system including:
the moving body above;
a transmission apparatus; and
a reception apparatus, wherein
the transmission apparatus comprises a transmission apparatus communication part that transmits the encryption key to the moving body, and
the reception apparatus comprises a reception apparatus communication part that receives the encryption key from the moving body.

According to a third aspect of the present disclosure, there is provided an encryption key delivery method, including:
a reception step for receiving an encryption key from a transmission apparatus;
a storing step for storing the encryption key received in a storage part;
a moving step for moving an own apparatus toward a reception apparatus after storing the encryption key;
an erasure step for erasing the encryption key stored in the storage part in a case where an abnormality of the own apparatus is detected during a movement; and
a transmission step for transmitting the encryption key stored in the storage part to the reception apparatus, upon arriving at a destination area.

According to a fourth aspect of the present disclosure, there is provided a program causing a computer loaded on a moving body to execute;
a reception step for receiving an encryption key from a transmission apparatus;
a storing step for storing the encryption key received in a storage part;
a moving step for moving an own apparatus toward a reception apparatus after storing the encryption key;
an erasure step for erasing the encryption key stored in the storage part in a case where an abnormality of the own apparatus is detected during a movement; and
a transmission step for transmitting the encryption key stored in the storage part to the reception apparatus, upon arriving at a destination area.

Further, this program can be recorded on a computer-readable storage medium.

The storage medium may be a non-transitory one such as semiconductor memory, a hard disk, a magnetic recording medium, an optical recording medium, and the like.

The present invention can also be realized as a computer program product.

### Advantageous Effects of Invention

According to present disclosure, it is possible to deliver an encryption key safely, without requiring a transmission line between a transmission side and a reception side, and without distance and transmission line constraints.

### BRIEF DESCRIPTION OF DRAWINGS

FIG. 1A is a schematic diagram illustrating one example of an encryption key delivery system of one example embodiment according to the present invention. FIG. 1B is a functional block diagram illustrating one example of a flying body of the key delivery system thereof.

FIG. 2A and FIG. 2B are a functional block diagram and a hardware configuration diagram of one example of a transmission apparatus according a first example embodiment, respectively.

FIG. 3A and FIG. 3B are a functional block diagram and a hardware configuration diagram of one example of a reception apparatus according the first example embodiment, respectively.

FIG. 4A and FIG. 4B are a functional block diagram and a hardware configuration diagram of one example of a flying body according to the first example embodiment, respectively.

FIG. 5 is a flowchart of one example of an encryption key delivery process in an encryption key delivery system according to the first example embodiment.

FIG. 6 is a flowchart of one example of an encryption key delivery process in a flying body according to the first example embodiment.

FIG. 7 is a schematic diagram illustrating one example of a configuration of an encryption key delivery system according to a second example embodiment.

FIG. 8A and FIG. 8B are a functional block diagram and a hardware configuration diagram of one example of a monitor apparatus according to the second example embodiment, respectively.

FIG. 9A is a functional block diagram of one example of a flying body according to a third example embodiment. FIG. 9B is a diagram illustrating one example of a log information according to the third example embodiment.

FIG. 10 is a flowchart of one example of an encryption key delivery process in the flying body according to the third example embodiment.

FIG. 11 is a schematic diagram illustrating one example of a configuration of an encryption key delivery system according to a fourth example embodiment.

FIG. 12 is a diagram illustrating an encryption key table according to the fourth example embodiment.

FIG. 13 is a schematic diagram illustrating one example of a configuration of an encryption key delivery system a according to a variation example of a present disclosure.

FIG. 14A is a schematic diagram illustrating one example of a configuration of an encryption key delivery system a according to other variation example of a present disclosure. FIG. 14B is a flowchart of one example of an encryption key delivery process in a flying body according thereto.

FIG. 15 is a schematic diagram illustrating one example of an encryption key table according to other variation example of a present disclosure.

FIG. 16 is a schematic diagram illustrating one example of a configuration of an encryption key delivery system a according to other variation example of a present disclosure.

### EXAMPLE EMBODIMENTS

Hereinafter, an example embodiment of the present disclosure is described with reference to drawings. Note that reference signs in the drawings provided here are for the sake of convenience for each element as an example to promote better understanding, and are not intended to limit the present disclosure to the illustrated modes. Connection lines between blocks in the drawings referred to in the following description can be both bidirectional and unidirectional. A unidirectional arrow schematically shows the main flow of a signal (data) and does not exclude bidirectionality.

A program is executed by a computer apparatus, and the computer apparatus is provided with, for example, a processor, a storage device, an input device, a communication interface, and a display device as needed. Further, the computer apparatus is configured to be able to perform wired or wireless communication with an internal device therein or with an external device (including a computer) via the communication interface. Although input/output connection points of each block in the drawings have ports or interfaces, these are not illustrated. Further, in the following description, “A and/or B” means at least one of A and B.

An example embodiment, which is an example of the present disclosure, is explained. The present example embodiment realizes an encryption key delivery system using a flying body as a moving body, which is difficult to wiretap. In the present example embodiment, an encryption key is loaded on the flying body and transmitted from a source device (transmission side) to a destination device (reception side). At this time, security is ensured using sensor signals from various sensors inside and outside the flying body. In the present example embodiment, an apparatus on the transmission side of the encryption key is referred to as a transmission apparatus and an apparatus on the reception side of the encryption key as a reception apparatus.

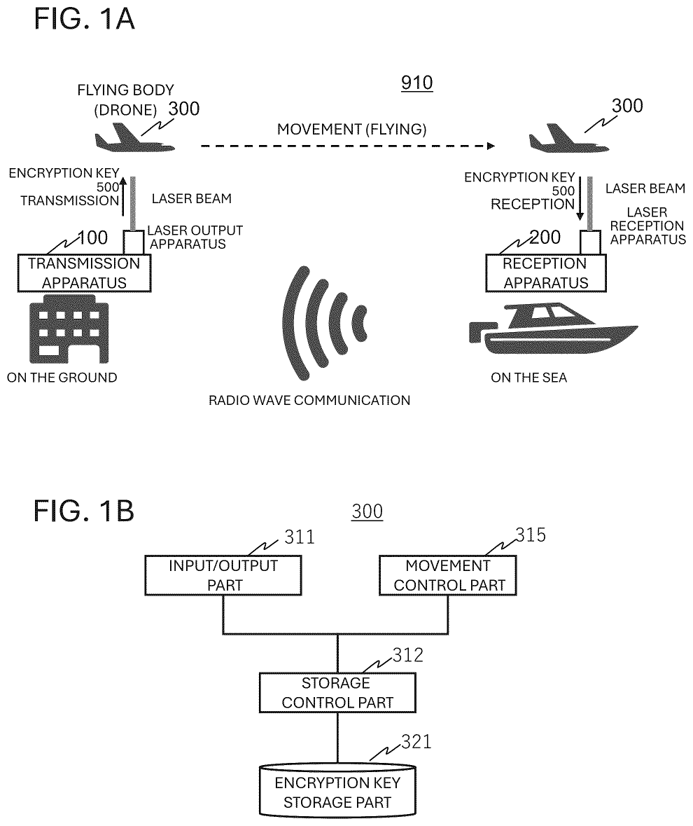

FIG. 1A illustrates an example of an encryption key delivery system 910 of an example embodiment of a present disclosure. As illustrated in FIG. 1A, the encryption key delivery system 910 is provided with a transmission apparatus 100, a reception apparatus 200, and a flying body 300.

In the example in FIG. 1A, the transmission apparatus 100 is disposed at a base on the land (on the ground). The reception apparatus 200 is disposed on, for example, a marine vessel on the sea. As the flying body 300, for example, a drone, which is an example of an unmanned aerial vehicle (UAV) capable of autonomous navigation, is used. Disposed locations of the transmission apparatus 100 and the reception apparatus 200 are not limited thereto.

In the encryption key delivery system 910 of the present example embodiment, an encryption key 500 is transmitted from the transmission apparatus 100 to the flying body 300, the flying body 300 flies to the reception apparatus 200, and the reception apparatus 200 receives the encryption key 500 from the flying body 300. Upon detecting an abnormality, the flying body 300 erases the encryption key 500 that it holds. Not only in a case of device abnormality, but also in a case where the encryption key 500 is wiretapped due to an unexpected circumstance or where the encryption key 500 is threatened with non-delivery, the flying body 300 determines that an abnormality has occurred and erases the encryption key 500. The unexpected circumstance may be, for example, contact with another flying body or a failure of the flying body 300 itself.

To realize this, the flying body 300 is provided with an input/output part 311, a storage control part 312, and a movement control part 315. The input/output part 311 receives the encryption key 500 from the transmission apparatus 100 and also transmits the encryption key 500 to the reception apparatus. The storage control part 312 stores the encryption key 500 in an encryption key storage part 321 upon receiving it from the transmission apparatus 100. The movement control part 315 moves the flying body 300 from the transmission apparatus 100 to the reception apparatus 200. The storage control part 312 then erases the encryption key 500 stored in the encryption key storage part 321 if an abnormality is detected during movement.

Note that the present example embodiment does not assume that a file (information itself) to be transmitted and received is actually loaded on the flying body 300. This is because, considering a flight speed of the flying body 300, real-time communication is not possible. Since the encryption key 500 only needs to be shared before communication, a delivery of the encryption key 500 is not required to be real-time compared to general communication.

### First Example Embodiment

Hereinafter, a first example embodiment of the present disclosure is described. According to the first example embodiment, in an encryption key delivery system 910, a flying body 300 is provided with an abnormality detection means to detect an abnormality that occurs during movement. The following is a detailed description of each apparatus.

### [Transmission Apparatus]

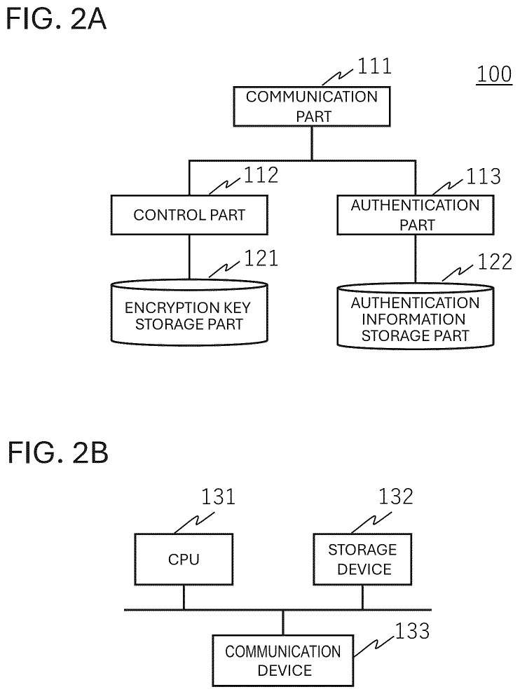

FIG. 2A illustrates a functional block diagram of a configuration related to the present example embodiment of a transmission apparatus 100. As illustrated in FIG. 2A, the transmission apparatus 100 is provided with a communication part 111, a control part 112, an authentication part 113, an encryption key storage part 121, and an authentication information storage part 122.

The encryption key storage part 121 stores an encryption key 500 therein. The encryption key 500 is generated in the transmission apparatus 100 or received from an external apparatus.

The information part authentication storage 122 stores authentication information therein. The authentication information is information to prove that the flying body 300 is authorized to deliver the encryption key 500. The authentication information is set in advance for each flying body 300, and the transmission apparatus 100, the reception apparatus 200, and the flying body 300 hold the same information. The authentication information is stored in the authentication information storage part 122 in advance.

The communication part 111 transmits and receives data to and from an external apparatus. In the present example embodiment, the communication part 111 transmits and receives the encryption key 500 and the authentication information to and from flying body 300.

As described above, a laser beam, for example, is used to transmit the encryption key 500 from the transmission apparatus 100 to the flying body 300. The communication using a laser beam can have quantumness. Therefore, the communication part 111 transmits the encryption key 500 to the flying body 300, for example, with a quantum communication or a quantum cryptography communication.

The communication part 111 may transmit and receive the authentication information by a laser beam as well as the encryption key 500. The communication part 111 may transmit and receive the authentication information by short-range radio communication such as Bluetooth (registered trademark) or Wi-Fi (registered trademark).

The authentication part 113 authenticates the flying body 300. Upon receiving the authentication information via the communication part 111, the authentication part 113 collates the received authentication information with the authentication information stored in the authentication information storage part 122 according to an instruction of the control part 112. After collation, the authentication part 113 notifies the control part 112 of the collation results. The authentication part 113 sets the collation result to “authentication success” in a case where the received authentication information and the stored authentication information match, and to “authentication failure” in a case where they do not match.

The control part 112 controls an operation of the entire transmission apparatus 100 and also controls transmission and reception of the encryption key 500 via the communication part 111. Concretely, the control part 112 reads the encryption key 500 from the encryption key storage part 121 upon receiving notification of authentication success from the authentication part 113 and transmits it to the flying body 300 via the communication part 111.

FIG. 2B illustrates a hardware configuration diagram of a configuration related to the present example embodiment of the transmission apparatus 100. As illustrated in the diagram, the transmission apparatus 100 is provided with a CPU 131, a storage device 132, and a communication device 133.

The CPU 131 loads a program stored in a non-volatile area of the storage device 132 into a work area and executes it to realize each of above functions and to comprehensively control the entire transmission apparatus 100. One or more processors such as a micro processing unit (MPU) may be used instead of the CPU 131.

The storage device 132 is configured with a memory such as a ROM (Read Only Memory) or a RAM (Random Access Memory). The storage device 132 stores information such as programs for executing each function and communication parameters for communication. In the present example embodiment, each of the above storage parts is constructed in the storage device 132.

In addition to memories such as a ROM and a RAM, the storage device 132 may be provided with storage media such as an SSD (Solid State Drive), a flexible disk, a hard disk, an optical disk, a CD-ROM, a CD-R, a magnetic tape, a non-volatile memory card, a DVD, etc. The storage device 132 may be provided with a plurality of memories, etc.

The communication device 133 realizes data transmission and reception. In the present example embodiment, the communication device 133 is provided with, for example, a laser beam output apparatus (luminous source) that outputs a laser beam and an optical wireless communication apparatus having a laser beam reception apparatus, etc. A laser diode (LD), a light emitting diode (LED), etc. that outputs a visible laser beam may be used as the luminous source.

In addition, the communication device 133 may also use, radio waves, sound waves, etc., as well as visible light to transmit and receive data. Concretely, the communication device 133 may be provided with a transmitter/receiver in accordance with other wireless communication schemes, such as Bluetooth, Wi-Fi, NFC (Near Field Communication), etc.

### [Reception Apparatus]

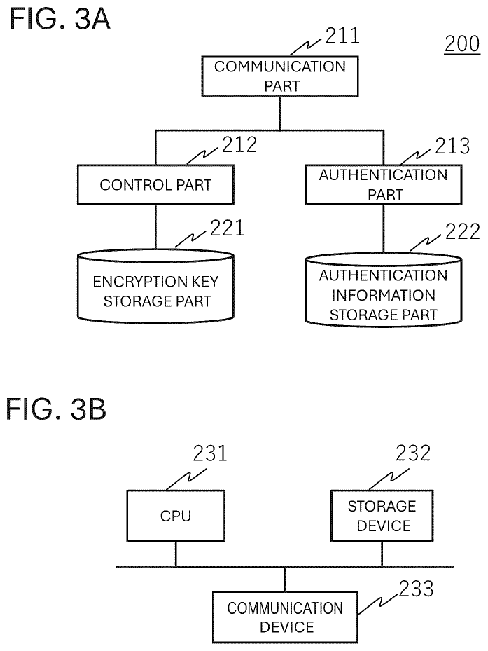

FIG. 3A illustrates a functional block diagram of a configuration related to the present example embodiment of the reception apparatus 200. As illustrated in the diagram, the reception apparatus 200 is provided with a communication part 211, a control part 212, an authentication part 213, an encryption key storage part 221, and an authentication information storage part 222, and an authentication information storage part 222.

The control part 212 controls an operation of the entire reception apparatus 200 and also controls transmission and reception of the encryption key 500 via the communication part 211. Concretely, the control part 212 generates an encryption key transmission request upon receiving notification of authentication success from the authentication part 213 and transmits it to the flying body 300 via the communication part 111. The control part 212 stores an encryption key 500 in the encryption key storage part 221 upon receiving it in response to an encryption key transmission request. At this time, a signal, meaning storage completion, may be transmitted to the flying body 300.

Since each of the other functions of the reception apparatus 200 is basically the same as the function of the same name in the transmission apparatus 100, they are not described here. In a case where it is necessary to distinguish between the functions of the transmission apparatus 100 and the reception apparatus 200, each function is referred to as a transmission apparatus communication part 111, a reception apparatus communication part 211, a transmission apparatus control part 112, a reception apparatus control part 212, a transmission apparatus authentication part 113, and a reception apparatus authentication part 213, respectively.

FIG. 3B illustrates a hardware configuration diagram of a configuration related to the present example embodiment of the reception apparatus 200. As illustrated in the diagram, the reception apparatus 200 is provided with a CPU 231, a storage device 232, and a communication device 233. Since each configuration of the reception apparatus 200 is basically the same as that of the transmission apparatus 100 of the same name, they are not described here.

### [Flying Body]

Next, the flying body 300, which delivers the encryption key 500 from the transmission apparatus 100 to the reception apparatus 200, is described. In the present example embodiment, a case of using a drone as the flying body 300 will be used as described above.

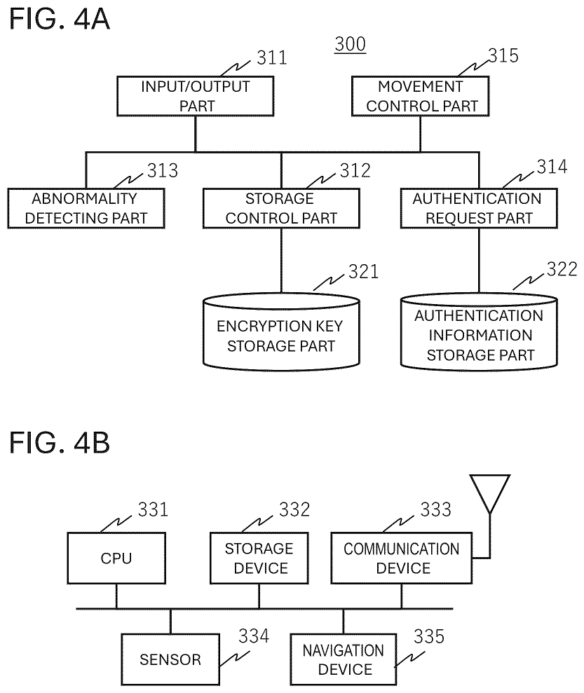

FIG. 4A illustrates a functional block diagram of a configuration related to the present example embodiment of the flying body 300. The flying body 300 of the present example embodiment is provided with the input/output part 311, the storage control part 312, the movement control part 315, and the encryption key storage part 321, as illustrated in FIG. 1A, as well as an abnormality detecting part 313, an authentication request part 314, an authentication information storage part 322, and an authentication information storage part 322.

The encryption key storage part 321 stores the encryption key 500 therein. The encryption key 500 is received from the transmission apparatus 100.

The authentication information storage part 322 stores the authentication information of the flying body 300 therein.

The input/output part 311 performs input/output of data to/from an external apparatus. The data to be input/output includes the encryption key 500, authentication information, etc.

The input/output part 311 receives the encryption key 500 from the transmission apparatus 100 via wireless communication and transmits the encryption key 500 to the reception apparatus 200 via wireless communication as described above. The input/output part 311 transmits authentication information to the transmission apparatus 100 and the reception apparatus 200. The input/output part 311 may have a function that allows data to be transmitted and received only under predetermined conditions, such as time and location.

As described above, transmission and reception of the encryption key 500 between the flying body 300 and the transmission apparatus 100 or the reception apparatus 200 may be done, for example, by quantum communication or quantum cryptography communication using a laser beam.

The authentication information may be transmitted and received via a laser beam as well as the encryption key 500. The authentication information may also be transmitted and received via Bluetooth, Wi-Fi, or other short-range radio communication.

The authentication request part 314 requests authentication to the external apparatus. In the present example embodiment, the authentication request part 314 requests authentication to the transmission apparatus 100 and the reception apparatus 200. The authentication request part 314 transmits authentication information stored in the authentication information storage part 322 to request authentication. Upon receiving a notification from the movement control part 315, described below, that an own apparatus (the flying body 300) has entered an area in which it can communicate with the external apparatus subject to the authentication request (hereinafter referred to as a communicable area), the authentication request part 314 requests authentication.

The abnormality detecting part 313 monitors a status of the flying body 300 and transmits an abnormality detecting signal to the storage control part 312 in a case where an abnormality is detected.

The abnormality detecting part 313 collects, for example, sensor detection values transmitted from a sensor 334, described below. The abnormality detecting part 313 outputs an abnormality detecting signal in a case where the collected sensor detection values have abnormality (abnormal value(s)). Whether or not the value is abnormal is determined by whether or not it exceeds an allowable range predetermined for each sensor. The allowable range is predetermined by, for example, a threshold value.

The abnormality detecting part 313 may also analyze the collected sensor detection values to determine presence or absence of abnormality. The abnormality detecting part 313 may also detect, for example, that the flying body 300 is no longer able to fly, has crash-landed or crashed, has a dead battery or program trouble, etc.

The storage control part 312 controls storing the encryption key 500 in the encryption key storage part 321, as described above. In the present example embodiment, the storage control part 312, for example, acquires the encryption key 500 via the input/output part 311 and stores it in the encryption key storage part 321. Upon receiving an encryption key transmission request, the storage control part 312 reads the encryption key 500 from the encryption key storage part 321 and transmits the encryption key 500 to the request source via the input/output part 311. The storage control part 312 further erases the encryption key 500 stored in the encryption key storage part 321 upon receiving an abnormality detecting signal from the abnormality detecting part 313.

The movement control part 315 navigates the flying body 300 to its destination as described above. In the present example embodiment, the movement control part 315 navigates the flying body 300 from the transmission apparatus 100 to the reception apparatus 200. In the present example embodiment, upon receiving the encryption key 500 from the transmission apparatus 100, the movement control part 315 controls the navigation device (see below) and moves the flying body 300 to the reception apparatus 200.

A hardware configuration of the flying body 300 is described below. FIG. 4B illustrates a hardware configuration diagram of a configuration related to the present example embodiment of the flying body 300. As illustrated in the diagram, the flying body 300 is provided with a CPU (Central Processing Unit) 331, a storage device 332, a communication device 333, a sensor 334, and a navigation device 335.

The CPU 331 loads a program stored in a non-volatile area of the storage device 332 into a work area and executes it to realize each of above functions and to comprehensively control the entire flying body 300. One or more processors such as a micro processing unit (MPU) may be used instead of the CPU 331.

The storage device 332 is configured with a memory such as a ROM (Read Only Memory) or a RAM (Random Access Memory). The storage device 332 stores information such as programs for executing each function and communication parameters for communication. In the present example embodiment, each of the above storage parts is constructed in the storage device 332.

In addition to memories such as a ROM and a RAM, the storage device 332 may be provided with storage media such as an SSD (Solid State Drive), a flexible disk, a hard disk, an optical disk, a CD-ROM, a CD-R, a magnetic tape, a non-volatile memory card, a DVD, etc. The storage device 332 may be provided with a plurality of memories, etc.

The communication device 333 communicates with an external apparatus. In the present example embodiment, the communication device 333 performs wireless communication with, for example, the transmission apparatus 100 and the reception apparatus 200. As described above, the encryption key 500 is transmitted and received via a laser beam. Therefore, the communication device 333 is provided with a laser input apparatus and a laser beam reception apparatus. The communication device 333 may also be provided with a near-distance communication device that transmits and receives authentication information.

The sensor 334 is provided in each part of the flying body 300 and detects its status. The sensor 334 is set up to detect (observe) all events that affect a flight of the flying body 300, such as vibration, contact, temperature change, voltage, position (latitude, longitude, and height), movement speed (flight speed), travel time, contact with other devices (other objects), interference, etc. The sensor 334 may be capable of detecting whether or not data is being transmitted to or received from other apparatuses. In the present example embodiment, the sensor 334 includes, for example, a gyro sensor, acceleration sensor, barometric sensor, ultrasonic sensor, geomagnetic sensor (electronic compass), camera, GPS device, battery level sensor, etc.

These detection values are output to the abnormality detecting part 313 and the movement control part 315, which are used to detect abnormality and control navigation using the navigation device 335.

The navigation device 335 navigates the flying body 300 according to a control of the movement control part 315. In the present example embodiment, the navigation device 335 is provided with, for example, a propeller and a motor to rotate the propeller. The movement control part 315 controls the navigation device 335 according to a navigation program stored in the storage device 332 and an output from the sensor 334 to make the flying body 300 navigate. The movement control part 315, for example, adjusts an output of the motor and controls a speed of the propeller based on information obtained from the sensor 334.

### [Encryption Key Delivery Method]

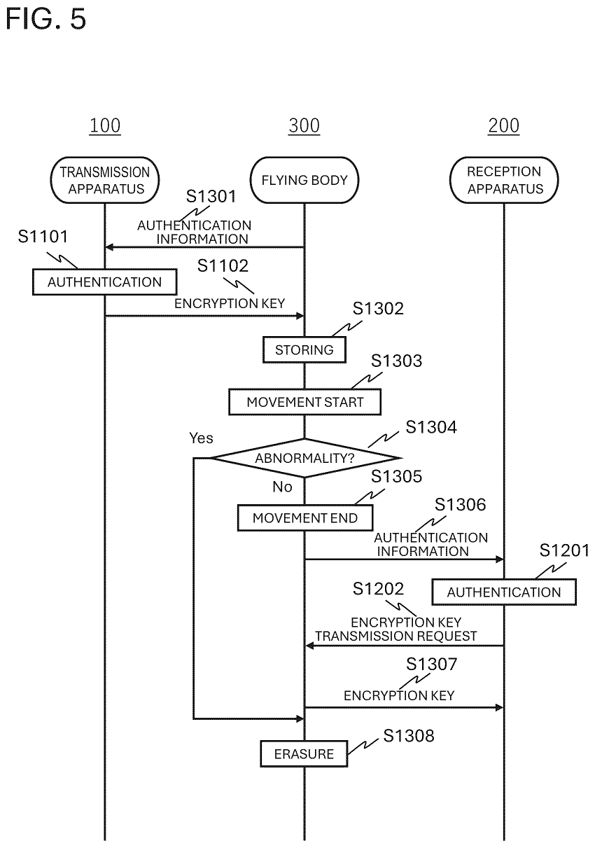

The following is an example flow of an encryption key delivery process using the encryption key delivery system 910 with the above configuration. FIG. 5 illustrates a flow diagram of an example of the encryption key delivery process by the encryption key delivery system 910 in the present example embodiment.

Upon reaching a communicable area of the transmission apparatus 100, the flying body 300 transmits authentication information to the transmission apparatus 100 (step S1301) and requests authentication.

Upon receiving authentication the information as an authentication request from the flying body 300, the transmission apparatus 100 performs authentication (step S1101). Here, the authentication part 113 collates the received authentication information with the authentication information stored in the authentication information storage part 122. If both match, the authentication part 113 notifies the control part 112 of the authentication success.

Upon receiving the authentication success notification, the control part 112 reads the encryption key 500 from the encryption key storage part 121 and transmits it to the flying body 300 of an authentication request source via the communication part 111 (step S1102).

If the authentication is unsuccessful, the transmission apparatus 100 does not transmit the encryption key 500 to the flying body 300 of the authentication request source. In this case, a message indicating authentication failure, etc. may be transmitted to the flying body 300 of the authentication request source.

Upon receiving the encryption key 500, the flying body 300 stores it (step S1302) and starts moving (step S1303).

Upon reaching a communicable area of the reception apparatus 200 without abnormality being detected (step S1304; No), the flying body 300 terminates its movement (step S1305). Then, the flying body 300 transmits the authentication information to the reception apparatus 200 (step S1306) and requests authentication.

Upon receiving the authentication information an as authentication request from flying body 300, the reception apparatus 200 performs authentication (step S1201). Here, authentication part 213 collates the received authentication information with the authentication information stored in the authentication information storage part 222. If both match, the authentication part 213 notifies the control part 212 of the authentication success.

Upon receiving notification of authentication success, the control part 212 generates an encryption key transmission request and transmits thereof to the flying body 300 of the authentication request source via communication part 111 (step S1202).

In a case where the authentication is unsuccessful, the reception apparatus 200 does not transmit the encryption key transmission request to the flying body 300 of the authentication request source. In this case, a message indicating authentication failure may be transmitted to the flying body 300 of the authentication request source.

Upon receiving the encryption key transmission request from the reception apparatus 200, the flying body 300 transmits the stored encryption key 500 to the reception apparatus 200 of the request source (step S1307). Then the flying body 300 erases the stored encryption key 500 (step S1308).

On the other hand, if an abnormality is detected during movement (step S1304; Yes), the flying body 300 erases the stored encryption key 500 (step S1308) and terminates the process.

After receiving the encryption key 500 in step S1307, the reception apparatus 200 communicates to the transmission apparatus 100 that the reception apparatus 200 has received the encryption key 500, using radio wave or the like and starts to use the encryption key 500. After receiving encryption key 500, the cryptographic algorithm used in the reception apparatus 200 is not limited. The encryption key 500 transmitted and received is not used for encryption and decryption as it is, but may be used by being converted using an algorithm stored in advance in the transmission apparatus 100 and the reception apparatus 200.

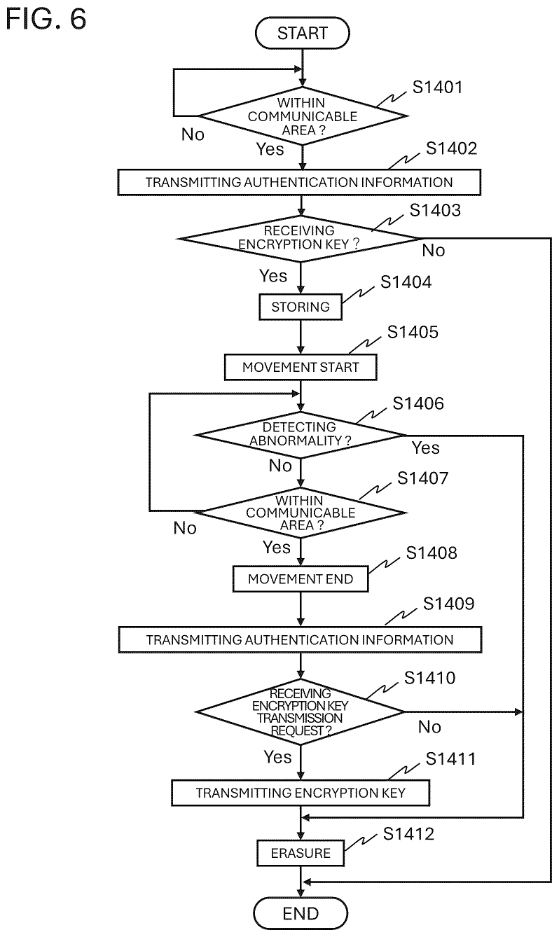

Next, an example of a process in the flying body 300 at a time of encryption key delivery is described. FIG. 6 illustrates a flowchart of an encryption key delivery process by the flying body 300 of the present example embodiment.

The movement control part 315 determines whether the flying body 300 has reached within a communicable area of the transmission apparatus 100 (step S1401). It does not matter which determination method is used. Various existing determination methods can be used. For example, a laser beam for distance measurement may be transmitted to the communication part 111, and if a distance value obtained is equal to or less than a predetermined value, the movement control part 315 may determine that it has reached therewithin. The movement control part 315 may determine using the captured images obtained by a camera. If a location of the transmission apparatus 100 is known, the movement control part 315 may determine using, for example, GPS functionality.

In a case where the flying body 300 reaches the communicable area, the authentication request part 314 makes an authentication request. Here, as described above, the authentication request part 314 transmits the authentication information stored in the authentication information storage part 322 to the transmission apparatus 100 (step S1402).

Upon receiving the encryption key 500 within a predetermined period of time from the transmission apparatus 100 in response to the authentication request (step S1403), the storage control part 312 stores the encryption key 500 in the encryption key storage part 321 (step S1404).

If the flying body 300 does not receive the encryption key 500 within a predetermined period of time, for example, if it receives a message of the authentication failure or if it receives no reply, it terminates the process.

Next, after finishing storing the encryption key 500, the movement control part 315 causes the flying body 300 to start moving (step S1405). Here, the movement control part 315 controls the navigation device 335 to move the flying body 300 to a communicable area of the reception apparatus 200 (step S1407).

During movement, upon detecting an abnormality (step S1406), the abnormality detecting part 313 outputs an abnormality detecting signal to the storage control part 312. Upon receiving the abnormality detecting signal, the storage control part 312 erases the encryption key 500 stored in the encryption key storage part 321 (step S1412) and terminates the process.

On the other hand, if the flying body 300 reaches the communicable area without detecting abnormality (step S1407), the movement control part 315 terminates the movement thereof (step S1408). The method for determining whether or not it reaches the communicable area of the reception apparatus 200 is the same as that used for the transmission apparatus 100.

Then, the authentication request part 314 makes an authentication request to the reception apparatus 200. Here, the authentication request part 314 transmits the authentication information stored in the authentication information storage part 322 to the reception apparatus 200 (step S1409).

Upon receiving an encryption key transmission request within a predetermined period of time from the reception apparatus 200 in response to the authentication request (step S1410), the storage control part 312 reads the encryption key 500 from the encryption key storage part 321 and transmits it to the reception apparatus 200 via the input/output part 311 (step S1411). Then, the storage control part 312 erases the encryption key 500 in the encryption key storage part 321 (step S1412) and terminates the process.

If the flying object 300 does not receive the encryption key transmission request within the predetermined period of time, for example, if it receives a message of the authentication failure, or if it receives no reply, it moves to step S1412.

As explained above, in the encryption key delivery system 910 of the present example embodiment, a flying body 300 is used to deliver the encryption key 500 between the transmission apparatus 100 and the reception apparatus 200. The flying body 300 is provided with an abnormality detecting function, and if an abnormality is detected in the flying body 300, the encryption key 500 to be delivered is erased.

For the flying body 300, a flying body capable of unmanned and autonomous navigation, such as a drone, is used. The flying body 300 is not susceptible to physical contact as long as it is flying at a sufficient altitude. Thus, the encryption key delivery system 910 in the present example embodiment uses the flying body 300 to deliver the encryption key 500. This allows the system 910 to achieve high security key delivery with little risk of wiretapping, for example, even between two points where no transmission line is drawn, without any restrictions on distance or transmission line.

For example, as illustrated in FIG. 1A, if a transmission apparatus 100 is disposed at a base on the land and a reception apparatus 200 is disposed on a marine vessel sailing on the sea, it is difficult to connect both apparatuses with physical cables because the marine vessel moves. In a situation where such a transmission line cannot be secured, the encryption key delivery system 910 of the present example embodiment is particularly useful.

The encryption key delivery system 910 of the present example embodiment also uses wireless communication for transmitting and receiving the encryption key 500 between the transmission apparatus 100 and the flying body 300, or the reception apparatus 200 and the flying body 300. This means that encryption key 500 can be transmitted and received without a connector connection, eliminating the need to add a new hardware to the flying body 300 and reducing costs.

The encryption key delivery system 910 in the present example embodiment uses a laser beam for the wireless communication. The laser beam has a small diffusion. Therefore, at a time transmitting and receiving the encryption key 500 between the transmission apparatus 100 and the flying body 300, or between the reception apparatus 200 and the flying body 300, the transmission is focused on a very small area. This allows for a smaller transmitting/receiving interface area for each of the flying body 300, the transmission apparatus 100, and the reception apparatus 200. Therefore, in the encryption key delivery system 910 of the present example embodiment, attacks on a transmitting and receiving interface are extremely difficult, and encryption key delivery with high security can be realized.

For example, consider a case where the flying body 300 is wiretapped on its way to a destination. It is very difficult to access a small laser beam interface of the flying body 300, which is during navigation, to obtain information. Therefore, in order to obtain the encryption key 500, an attacker may capture the flying body 300.

However, in the encryption key delivery system 910 of the present example embodiment, in a case where the flying body 300 contacts an obstacle during navigation, the abnormality detecting part 313 detects changes in vibration, radio waves, temperature, etc., and outputs an abnormality detecting signal. Then, the storage control part 312 immediately erases the encryption key 500 stored in the encryption key storage part 321. Therefore, according to the encryption key delivery system 910 of the present example embodiment, even if the attacker captures the flying body 300, the encryption key 500, which was in the flying body 300, cannot be obtained because it has been erased. The encryption key delivery system 910 of the present example embodiment can realize highly secure encryption key delivery from this point of view as well.

A use of a laser beam allows a transmission line to be visually confirmed, even in wireless communication, making it easy to set an area range and to set a position for transmission and reception with high accuracy. Therefore, according to the encryption key delivery system 910, an encryption key delivery, which is difficult to intercept and wiretapping, with a high success probability can be realized. Furthermore, according to the encryption key delivery system 910, by using a laser beam, a quantum cryptography can be used for transmission and reception of the encryption key 500 between the transmission apparatus 100 and the flying body 300 or the reception apparatus 200 and the flying body 300. This enables an encryption key delivery having the same security as a case where the encryption key 500 is delivered directly between the transmission apparatus 100 and the reception apparatus 200 using quantum cryptography.

In the present example embodiment, during communication between the flying body 300 and the transmission apparatus 100 and/or the reception apparatus 200, the transmission apparatus 100 and/or reception apparatus 200 may output a laser beam therefrom, or the flying body 300 may output a laser beam to these apparatuses. Different transmission and reception mechanisms may be used in a communication between the transmission apparatus 100 and the flying body 300, and in a communication between the reception apparatus 200 and the flying body 300, respectively.

In the present example embodiment, the flying body 300 side determines whether or not it has entered the communicable area. However, this may be done by the transmission apparatus 100 and the reception apparatus 200 sides.

In this case, the transmission apparatus 100 and the reception apparatus 200 are provided with sensors and the like to detect the flying body 300, and these detect that the flying body 300 has entered the communicable area. Then, the transmission apparatus 100 or the reception apparatus 200 transmits an authentication information transmission request to the flying body 300.

In the present example embodiment, the flying body 300 immediately erases the stored encryption key 500 upon transmitting the encryption key 500 to the reception apparatus 200. However, it is not limited thereto. For example, it may be configured to erase the stored encryption key 500 after the flying body 300 confirms that the reception apparatus 200 has received thereof.

In this case, upon receiving the encryption key 500, the reception apparatus 200 transmits a reception notice to the flying body 300. The flying body 300 waits for a receipt of the reception notice and then erases the stored encryption key 500. The flying body 300 may be configured to transmit the encryption key 500 multiple times to the reception apparatus 200 until it receives a reception notice.

In a case where the flying body 300 has erased the stored encryption key 500, it may notify the transmission apparatus 100 and/or the reception apparatus 200 thereof. Also, in a case where the authentication is unsuccessful in step S1201 above, the reception apparatus 200 may transmit a message that means authentication failure in plain text to the transmission apparatus 100 therefrom.

### Second Example Embodiment

Next, a second example embodiment of the present disclosure is described. The encryption key delivery system 910 in the first example embodiment uses the sensor 334 mounted on the flying body 300 to detect an abnormality during delivery. In the present example embodiment, a flying body 300 is further monitored by an external apparatus to detect an abnormality of the flying body 300.

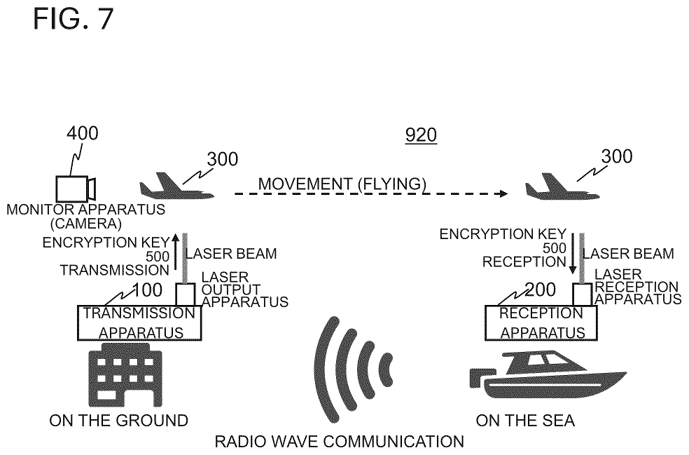

FIG. 7 illustrates an example of an encryption key delivery system 920 in the present example embodiment. As illustrated in the figure, the encryption key delivery system 920 of the present example embodiment has basically the same configuration as that of the first example embodiment. That is, the encryption key delivery system 920 is provided with a transmission apparatus 100, a reception apparatus 200, and a flying body 300. The encryption key delivery system 920 of the present example embodiment is further provided with a monitor apparatus 400. The following description of the present example embodiment focuses on the monitor apparatus 400, which is a different configuration from the first example embodiment.

The monitor apparatus 400 monitors the flying body 300 and its surroundings from the outside. The monitor apparatus 400 is configured with, for example, a camera and/or a radio wave reception and transmission apparatus.

The monitor apparatus 400, for example, in a case where it is a camera, is installed so that the flying body 300 is in its field of view. In a case where it is a radio wave reception and transmission apparatus, the monitor apparatus 400 is installed so that the flying body 300 enters in a direction of radio wave emission.

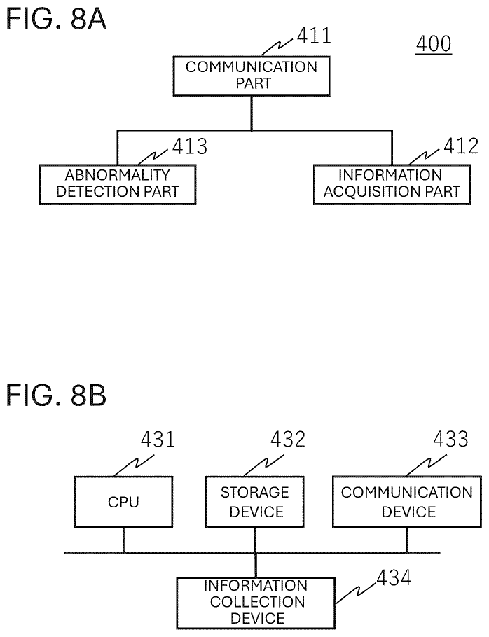

FIG. 8A and FIG. 8B illustrate a functional block of the monitor apparatus 400 and a hardware configuration of the monitor apparatus 400, respectively.

As illustrated in these drawings, the monitor apparatus 400 is provided with a communication part 411, an information acquisition part 412, and an abnormality detection part 413. The monitor apparatus 400 is provided with a CPU 431, a storage device 432, a communication device 433, and an information collection device 434.

The information collection device 434 collects information on and near the flying body 300. The information collection device 434 is an imaging unit in a case where it is a camera, or a radio wave receiver/transmitter in a case where it is a radio wave reception and transmission apparatus.

The information acquisition part 412 controls an operation of the information collection device 434 and passes information it collects at predetermined time intervals to the abnormality detection part 413. In the present example embodiment, the information acquisition part 412 collects image or reflected wave information.

The abnormality detection part 413 analyzes images or reflected waves acquired by the information acquisition part 412 to determine presence or absence of an abnormality in the flying body 300. If the abnormality detection part 413 determines that an abnormality exists, i.e., if it detects an abnormality, it transmits an abnormality detecting signal to the flying body 300 via the communication part 411.

The communication part 411, the CPU 431, the storage device 432, and the communication device 433 are similar to configurations of the same name of, for example, the transmission apparatus 100 of the first example embodiment. Therefore, the explanation is omitted.

The flow of the encryption key delivery process of the present example embodiment is basically the same as that of the first example embodiment. However, in the present example embodiment, in step S1406, the storage control part 312 erases the encryption key 500 stored in the encryption key storage part 321 even if the abnormality detecting signal is received via the input/output part 311 as well as from the abnormality detecting part 313.

The monitor apparatus 400 may be installed on the ground, or it may be a satellite or other floating object. It may be, for example, a flying body that flies alongside the flying body 300. The transmission apparatus 100 or the reception apparatus 200 may also be provided with a monitor apparatus 400.

As explained above, the present example embodiment is provided with the same configuration as the first example embodiment and thus has the same effect as the first example embodiment. Furthermore, the encryption key delivery system 920 of the present example embodiment is provided with the monitor apparatus 400 that monitors the flying body 300 and the state of its surroundings from the outside. If the monitor apparatus 400 determines that the flying body 300 has abnormality, the flying body 300 also erases the encryption key 500 during delivery. Therefore, according to this embodiment, the abnormality of the flying body 300 can be discovered with a higher degree of accuracy, and the delivery of encryption key 500 with higher security can be realized.

In the present example embodiment, the flying body 300 does not have to be provided with the abnormality detecting part 313.

In the present example embodiment, the monitor apparatus 400 transmits an abnormality detecting signal directly to the flying body 300 in a case where it detects an abnormality. However, it is not limited to this. For example, the monitor apparatus 400 may be configured to transmit the abnormality detecting signal to the transmission apparatus 100 and/or the reception apparatus 200. In this case, the abnormality detecting signal is transmitted from these apparatuses to the flying body 300.

### Third Example Embodiment

Next, a third example embodiment of the present disclosure is described.

In each of the above example embodiments, the flying body 300 is monitored in real time during movement to detect the abnormality of the flying body 300. In the present example embodiment, sensor detection values during movement is accumulated as log information. Then, for example, after the flying body 300 reaches a vicinity of the reception apparatus 200, this log information is further analyzed to detect presence or absence of abnormality.

Configuration of the encryption key delivery system, the transmission apparatus 100, and the reception apparatus 200, and a hardware configuration of the flying body 300 are basically the same as those of the first example embodiment, and therefore explanation is omitted here.

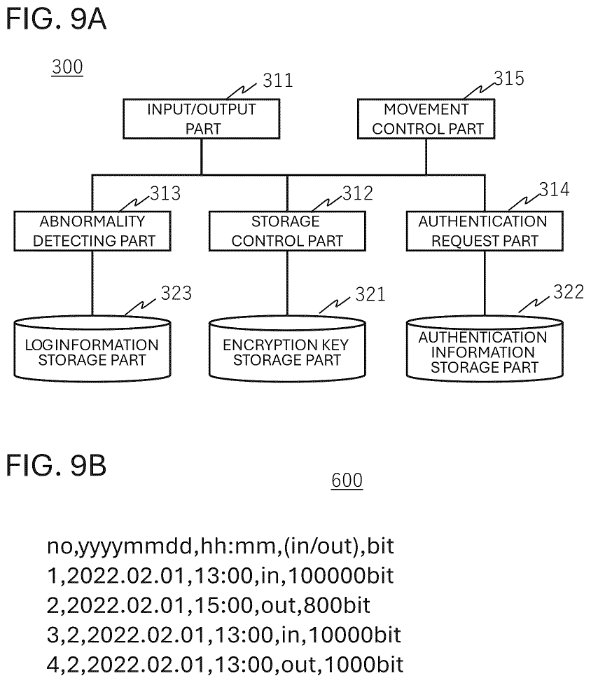

An example of a functional block of the flying body 300 of the present example embodiment is illustrated in FIG. 9A. As illustrated in the drawing, the flying body 300 of the present example embodiment is provided with a log information storage part 323 in addition to the configuration of the flying body 300 of the first example embodiment. The log information storage part 323 is constructed in the storage device 332.

The abnormality detecting part 313 of the present example embodiment stores the collected sensor detection values as log information in the log information storage part 323 in correspondence with a detection time (or collection time) in addition to performing a process of the first example embodiment.

The abnormality detecting part 313 collects and stores not only the sensor detection value of the sensor 334 that detects a state of the flying body 300, but also access history to the storage device 332 as log information.

In addition, the abnormality detecting part 313 of the present example embodiment performs a log information verification process after the flying body 300 reaches a communicable area of the reception apparatus 200. The log information verification process is a process analyzing log information and verifying whether there is an abnormality. In a case where an improper log is detected in the log information verification process, the abnormality detecting part 313 determines that an abnormality exists and outputs an abnormality detecting signal. Similar to the first example embodiment, the storage control part 312 erases the encryption key 500 in the encryption key storage part 321 upon receiving the abnormality detecting signal.

For example, if log information 600 illustrated in FIG. 9B is recorded as an access log to the encryption key storage part 321, the abnormality detecting part 313 determines that an abnormality exists and outputs the abnormality detecting signal.

In a case where the flying body 300 receives the encryption key 500 from the transmission apparatus 100, after it stores (in) the encryption key 500 in the encryption key storage part 321, no access will be occurred until it passes the encryption key 500 to the reception apparatus 200. However, in the log information 600, the read (out) is recorded twice. Therefore, the abnormality detecting part 313 determines that there is an improper access, i.e., there is an abnormality.

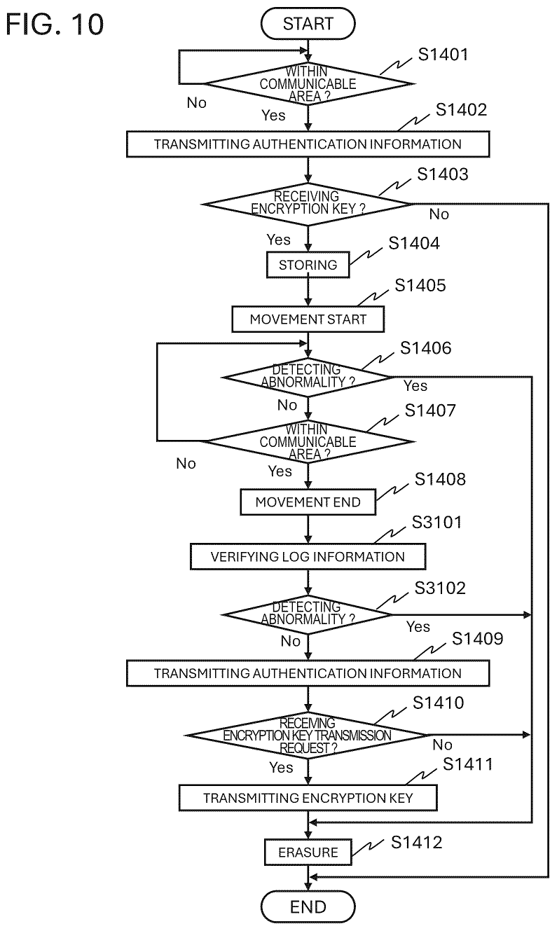

FIG. 10 illustrates an example of a process at the time of encryption key delivery by the flying body 300 of the present example embodiment. It is the same as in the first example embodiment until the flying body 300 reaches the reception apparatus 200 (step S1408).

In the present example embodiment, the abnormality detecting part 313 then performs a log information verification process (step S3101). If the abnormality detecting part 313 determines that there is an abnormality in the log information verification process (step S3102; Yes), it outputs an abnormality detecting signal. Then, in response, the storage control part 312 erases the encryption key 500 in the encryption key storage part 321 (step S1412).

On the other hand, if the abnormality detecting part 313 finds an abnormality during the log information verification process (step S3102; No), it moves the process to step S1409 and continues the same process as the first example embodiment. The log information verification process may be performed at any time between the end of the movement and the transmission of the encryption key.

As explained above, the present example embodiment is provided with the same configuration as the first example embodiment and thus has the same effect as the first example embodiment. In addition, the present example embodiment also verifies presence or absence of abnormality using accumulated information. This allows for the delivery of 500 encryption keys with higher security.

Even if an attacker attempts wiretapping in a way that disables an abnormality detecting function, for example, by accessing a laser beam interface without contacting an airframe of the flying body 300, the present example embodiment can confirm the presence or absence of the wiretapping by checking the transmission and reception log of the encryption key 500.

In the present example embodiment, the log information is stored in the flying body 300 and a log information verification process is performed therein but is not limited to this. It may be configured that, during the movement of the flying body 300, the log information of the flying body 300 may be transmitted to the transmission apparatus 100 or the reception apparatus 200, which accumulate the log information and perform the log information verification process. In this case, in a case where the abnormality is detected, an abnormality detecting signal is transmitted from these apparatuses to the flying body 300.

In addition, the present example embodiment, like the second example embodiment, may be provided with a monitor apparatus 400. In this case, the monitor apparatus 400 may also accumulate the collected information as the log information and perform the log information verification process. It may be configured that, the log information accumulated by the monitor apparatus 400 may be transmitted to the transmission apparatus 100 or the reception apparatus 200, which performs the log information verification process. In this case, in a case where the abnormality is detected, also, an abnormality detecting signal is transmitted from these apparatuses to the flying body 300.

The reception apparatus 200 may combine a result of monitoring by the monitor apparatus 400 with the log information to make a more detailed determination of the presence or absence of abnormality. For example, a satellite camera or radio wave is used to track the flying body 300 until it passes data to the reception apparatus 200. As a method of detecting an abnormality at this time, if an unscheduled object approaches the flying body 300 and contacts it, the reception apparatus 200 is notified. The reception apparatus 200 may determine that the flying body 300 is being abused if an abnormality is confirmed against the log information (flight log or contact log) of flying body 300. If an unscheduled object contacts the flying body 300, it may be assumed to have been wiretapped, and an abnormality detection signal may be transmitted to the flying body 300 to erase the encryption key 500 in the flying body 300.

In addition, the reception apparatus 200 may query the flight log of the flying body 300, sensor detection value log, transmission and reception log, etc., to the transmission apparatus 100 and/or the monitor apparatus 400 to determine if an unscheduled event has occurred. Then, if the reception apparatus 200 may determine that an unscheduled event has occurred, it may have the encryption key 500 in the flying body 300 erased for fear of wiretapping.

In addition, the reception apparatus 200 may determine whether a flight time is appropriate. In this case, the reception apparatus 200 may have the encryption key 500 in the flying body 300 erased if the flying body 300 has not arrived within a pre-determined time.

In this case, for example, upon transmitting the encryption key 500 to the flying body 300, the transmission apparatus 100, at the same time, transmits a message to the reception apparatus 200 indicating that it has transmitted the encryption key 500. If the flying body 300 does not arrive within a predetermined time from receipt of the message, the reception apparatus 200 generates an abnormality detecting signal. At this time, the reference apparatus 200 may search for the flying body 300 and transmit the abnormality detecting signal at the timing when it generates the abnormality detecting signal. At a time when authentication information is transmitted from the flying body 300, the reception apparatus 200 may reply with an abnormality detecting signal without performing authentication.

The storage control part 312 of the flying body 300 that receives the abnormality detecting signal erases the encryption key 500 without transmitting it to the reception apparatus 200.

The flying body 300 may determine whether a flight time is appropriate. That is, in a case where a predetermined time has elapsed since receipt of the encryption key 500, the storage control part 312 erases the encryption key 500 in the encryption key storage part 321.

The period of time until erasure can be specified at a time of individual delivery. For example, upon receipt of the encryption key 500, the flying body 300 may be configured to also receive a specification of the period of time until erasure, from transmission apparatus 100. The storage control part 312 erases the encryption key 500 after this period passes.

### Fourth Example Embodiment

Next, a fourth example embodiment of the present disclosure is described. In each of the above example embodiments, one flying body 300 is navigated from the transmission apparatus 100 to the reception apparatus 200. On the other hand, in the present example embodiment, a plurality of flying bodies 300 is navigated from the transmission apparatus 100 to the reception apparatus 200, and a plurality of encryption keys 500 is delivered.

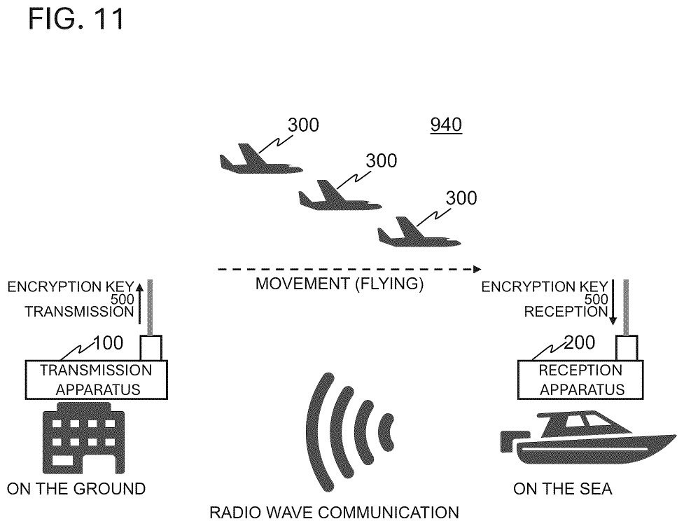

An example of the encryption key delivery system 940 of the present example embodiment is illustrated in FIG. 11. As illustrated in FIG. 11, the encryption key delivery system 940 is provided with a transmission apparatus 100 and a reception apparatus 200, similar to the first example embodiment. The encryption key delivery system 940 of the present example embodiment is further provided with a plurality of flying bodies 300.

The respective configurations of the transmission apparatus 100, the reception apparatus 200, and the flying body 300 are basically the same as in the first example embodiment. The following description of the present example embodiment focuses on its different configuration from that of the first example embodiment.

Each flying body 300 has its own unique authentication information. The transmission apparatus 100 of the present example embodiment stores the encryption key 500 in correspondence with authentication information in the encryption key storage part 121, as encryption key table 140. In the present example embodiment, the authentication information storage part 122 is not required.

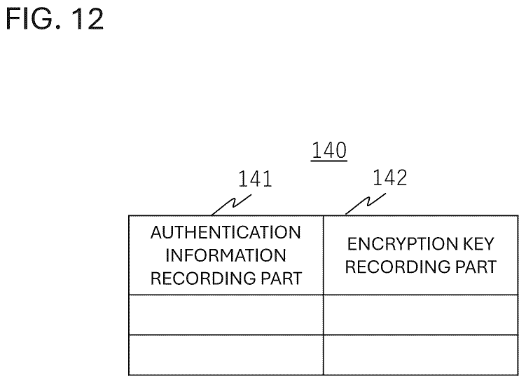

In the encryption key table 140, the encryption key 500 to be delivered is registered, corresponding to the authentication information of each flying body 300. An example of the encryption key table 140 of the present example embodiment is illustrated in FIG. 12.

As illustrated in FIG. 12, each record in the encryption key table 140 has an authentication information recording part 141 and an encryption key recording part 142. The authentication information recording part 141 stores the authentication information of each flying body 300 authorized to deliver the encryption key 500. The encryption key recording part 142 stores the encryption key 500 to be delivered with the flying body 300 identified by the corresponding authentication information.

The reception apparatus 200 may also have an encryption key table having records with the same entries. The authentication information recording part stores authentication information of all the flying bodies 300 authorized to deliver the encryption key 500, respectively.

In the authentication process of step S1101 in FIG. 5, the authentication part 113 collates all the authentication information stored in the authentication information recording part 141. If there is any matching authentication information, it transmits the encryption key 500, which is registered in correspondence with the authentication information matched, to flying body 300.

If none of the authentication information stored in the authentication information recording part 141 matches the authentication information, the authentication part 113 determines “authentication failure”.

In addition, in the authentication process of step S1201 in FIG. 5, the reception apparatus 200 collates all the authentication information stored in the authentication information recording part. If any of the authentication information matches, it transmits an encryption key transmission request to the flying body 300. Then, the reception apparatus 200 stores the encryption key 500 transmitted from the flying body 300, in response, in the encryption key recording part in correspondence with the matched authentication information.

This allows supply of the encryption keys 500 to be increased within the same time period, according to the present example embodiment.

The same encryption key 500 may be loaded and delivered in a plurality of flying bodies 300. In this case, the delivery of the encryption key 500 is more reliable.

In addition, the present example embodiment may include a dummy in the 500 encryption keys to be transmitted. A portion of the encryption key 500 to be transmitted may be a dummy, or the entire encryption key 500 delivered by a particular flying body 300 may be a dummy. The dummy key (bit) is not used as an encryption key. In this case, too, the encryption key 500 to be transmitted and received may be converted and used by the transmission apparatus 100 and the reception apparatus 200 using an algorithm stored in advance. Furthermore, determination of whether or not it is a dummy may be made using an algorithm stored in advance by the transmission apparatus 100 and the reception apparatus 200. These methods can reduce the risk of wiretapping, capture, etc.

Note that the present example embodiment may be combined with the second example embodiment.

### Variation Example 1

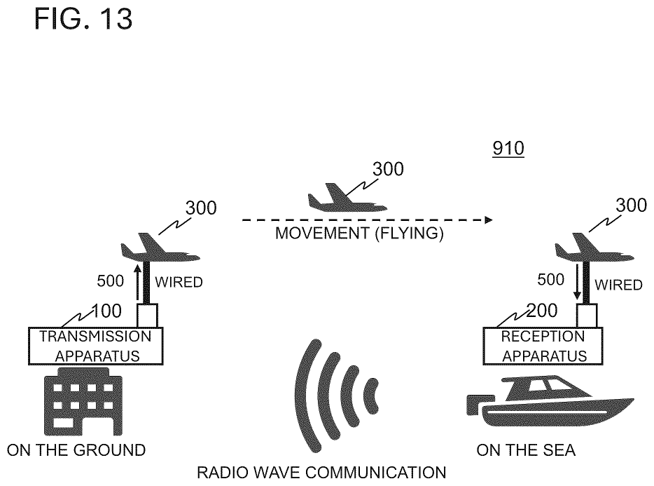

In each of the above example embodiments and variation examples, during transmission and reception of the encryption key 500 between the transmission apparatus 100 and the flying body 300 or the reception apparatus 200 and the flying body 300, the flying body 300 is in a gliding state and is transmitting/receiving the encryption key 500 by wireless communication. For example, the communication therebetween may be wired communication, as illustrated in FIG. 13. FIG. 13 illustrates an example of an encryption key delivery system 910 similar to the first example embodiment.

In this case, the flying body 300 lands in a vicinity of the transmission apparatus 100 or the reception apparatus 200 at the time of transmitting and receiving the encryption key 500. Then, as illustrated in this drawing, the two are connected by a physical cable to transmit and receive the encryption key 500.

In this case, the communication device 133 of the transmission apparatus 100, the communication device 233 of the reception apparatus 200, and the communication device 333 of the flying body 300 are provided with wired communication connectors. Furthermore, instead of the communication devices 133, 233, and 333, each apparatus may be provided with an interface that inputs/outputs data via a medium and transmits/receives the encryption key 500 via the medium.

As mentioned above, in a case where the transmission apparatus 100, the reception apparatus 200 and the flying body 300 are provided with multiple data communication and input/output interfaces, the exchange of the encryption key 500 between the transmission apparatus 100 and the flying body 300, and the exchange of the encryption key 500 between the reception apparatus 200 and the flying body 300 may be in different communication schemes, respectively.

In this case, the transmission and reception of information about authentication between the flying body 300 and the transmission apparatus 100 or the flying body 300 and the reception apparatus 200 may also be by wired cable. In each example embodiment and variation example, wired cables may be used only for transmitting and receiving information related to authentication.

### Variation Example 2

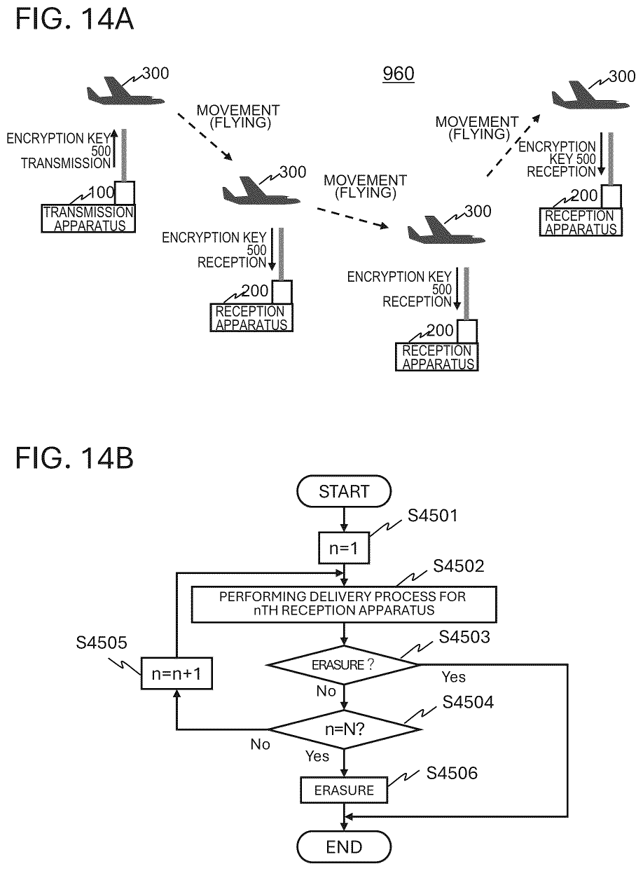

In each of the above example embodiments and variation examples, a case of delivery of an encryption key 500 from one transmission apparatus 100 to one reception apparatus 200 is explained as an example. However, it is not limited thereto. For example, as illustrated in FIG. 14A, the same encryption key 500 may be delivered by the same flying body 300 to a plurality of reception apparatuses 200 in sequence.

In this variation example, the movement control part 315 of the flying body 300 causes the flying body 300 to fly toward each of the reception apparatuses 200 in a predetermined order. Flight routes may be pre-programmed.

In this variation example, at the time of receiving the encryption key 500, the storage control part 312 receives from the transmission apparatus 100 the number of the reception apparatus 200 of delivery destination.

FIG. 14B illustrates a process flow at the time of encryption key delivery by the flying body 300 in this case. Note that the number of the reception apparatus 200 of delivery destination is N (N is an integer greater than or equal to 2).

Also, n is a counter.

The flying body 300 sets the counter n to an initial value of 1 (step S4501). Then, flying body 300 executes the process from step S1401 to step S1411 in FIG. 6, and executes the encryption key 500 delivery process to the reception apparatus 200 scheduled to deliver the nth (step S4502).

Thereafter, it is determined whether or not the encryption key 500 has been erased (step S4503). For example, if an abnormality is detected during the delivery process in step S4502, the encryption key 500 has already been erased. In this case, subsequent delivery is not possible, and the process is terminated as is.

On the other hand, if the encryption key 500 has not been erased, the flying body 300 repeats the delivery process, incrementing the counter by 1 until the last (Nth) reception apparatus 200 (steps S4504, S4505).

After the delivery process is completed up to the last reception apparatus 200, the storage control part 312 erases the encryption key 500 stored in the encryption key storage part 321 (step S4506) and terminates the process.

There may be a plurality of transmission apparatuses 100. In this case, the flying body 300 goes around a plurality of transmission apparatuses 100 in a predefined order and receives a different encryption key 500 from each transmission apparatus 100. Then, the flying body 300 delivers those encryption keys to the one reception apparatus 200.

Furthermore, there may be a plurality of transmission apparatuses 100 and a plurality of the reception apparatuses 200, respectively. Then, a plurality of encryption keys 500 may be received from one transmission apparatus 100, or a plurality of encryption keys 500 may be transmitted to one reception apparatus 200.

In this case, the flying body 300 receives the encryption key 500 together with, for example, information identifying the reception apparatus 200 of the transmission destination thereof (reception apparatus ID). Then, the flying body 300 stores it in the encryption key storage part 321 as a second encryption key table 150. The reception apparatus 200 also stores the reception apparatus ID in advance.

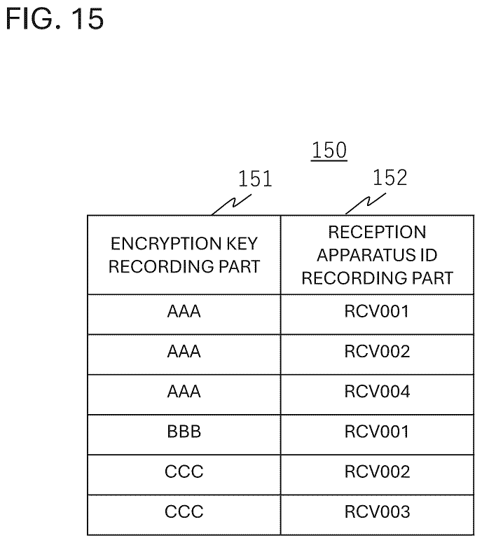

FIG. 15 illustrates one example of the second encryption key table 150. The second encryption key table 150 is provided with an encryption key recording part 151 and a reception apparatus ID recording part 152. The encryption key recording part 151 stores the encryption key 500 therein. The reception apparatus ID recording part 152 stores the reception apparatus ID therein. In a case where one encryption key 500 is delivered to a plurality of reception apparatuses 200, number records of delivery destinations having the same encryption key 500 are registered therein.

The flying body 300 receives the reception apparatus ID together with an encryption key transmission request from the reception apparatus 200, at a time of authentication each time it arrives at the reception apparatus 200. The flying body 300 then extracts all encryption keys 500 stored therein corresponding to the received reception apparatus ID and transmits them to the reception apparatus 200. Then, the delivered records in the second encryption key table 150 are erased.

For example, in the example illustrated in FIG. 15, in a case where the flying body 300 arrives at a reception apparatus 200 whose reception apparatus ID is RCV001, it transmits an encryption key AAA and an encryption key BBB to the reception apparatus 200. Then, it erases these records. In a case where the flying body 300 arrives at a reception apparatus 200 whose reception apparatus ID is RCV002, it transmits encryption keys AAA and CCC thereto and erases these records. In a case where the flying body 300 arrives at a reception apparatus 200 whose reception apparatus ID is RCV003, it transmits an encryption key CCC thereto and erases this record. In a case where the flying body 300 arrives at a reception apparatus 200 whose reception apparatus ID is RCV0034, it transmits an encryption key AAA thereto and erases this record.

### Variation Example 3

In each of the above example embodiments, a flying body that navigates according to a pre-stored program, such as a drone, is used as an example flying body 300, but the flying bodies 300 are not limited thereto. For the flying body 300, any object is available as long as it can move between two points (from the transmission apparatus 100 to the reception apparatus 200) unmanned. For example, it may be a remotely controllable flying body. It may also be a bullet or artillery shell that does not propel itself, but only moves with initial propulsion, while still being able to control its arrival position. Furthermore, it can be a manned, flyable device such as an airplane, helicopter, or glider. In this case, it is desirable to configure that a pilot is not able to access a storage part where the encryption key 500 is stored.

The device that delivers the encryption key 500 from the transmission apparatus 100 to the reception apparatus 200 is not limited to flying bodies. It can be an object that can move between two apparatuses which cannot have a transmission line therebetween and that are difficult to access by other objects. For example, it can be a vehicle traveling on the ground, such as an automated vehicle, or a moving body, such as a marine vessel.

### Variation Example 4

It can be configured to earn profit using the encryption key delivery system of each example embodiment or each variation example above.

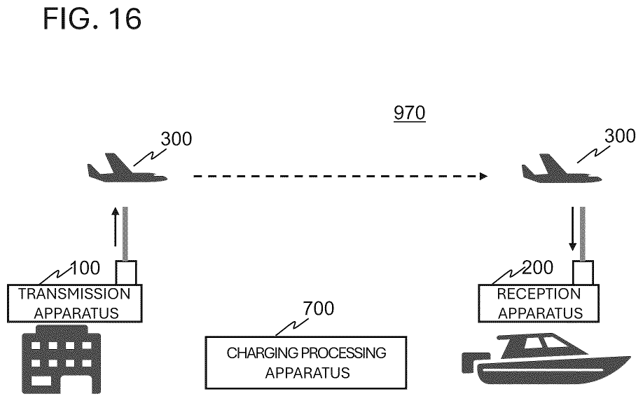

In this case, as illustrated in FIG. 16, an encryption key delivery system 970 is provided with a charging processing apparatus 700 in addition to the configuration of each of the above example embodiments. The case in which the charging processing apparatus 700 is added to the configuration of the first example embodiment is illustrated here. The base encryption key delivery system may be an encryption key delivery system of any other example embodiment or variation example.

The charging processing apparatus 700 obtains predetermined charging parameters such as the number of navigation courses, delivery distance, the number of deliveries, data volume, non-delivery information, etc., each time the encryption key delivery process by the flying body 300 occurs.

The number of navigation courses is the number of combinations of the transmission apparatus 100 and the reception apparatus 200. The number of navigation courses may be received from any of the transmission apparatus 100, the reception apparatus 200 and the flying body 300.

The delivery distance is a distance between the transmission apparatus 100 and the reception apparatus 200 for each delivery. The distance may be calculated from GPS data between the two, for example, or from the flight distance obtained from the flight log of flying body 300. For example, if the transmission apparatus 100 and/or the reception apparatus 200 moves, it may be the distance at the time of departure or the distance at the time of arrival.

The number of deliveries is the number of encryption keys 500 delivered. The charging processing apparatus 700 collects, for example, the number of encryption keys 500 transmitted by the transmission apparatus 100 and/or the number of encryption keys 500 received by the reception apparatus 200.

The data volume is an amount of data of the encryption key 500 to be delivered. The charging processing apparatus 700 collects, for example, the amount of data transmitted by the transmission apparatus 100 and/or the amount of data received by the reception apparatus 200.

The non-delivery information is information that means that the information has been non-delivery. For example, if the flying body 300 erases the encryption key 500 before delivery to the reception apparatus 200, it also transmits that information to the charging processing apparatus 700. Alternatively, it may transmit this information via the transmission apparatus 100 or the reception apparatus 200.

The charging processing apparatus 700 collects these charging parameters, sums them up for each predetermined period, calculates a charging amount according to predetermined calculation conditions, and charges the predetermined charging destination. The calculation condition may be, for example, a calculation method that multiplies the delivery distance, data volume, and predetermined coefficient of successful deliveries over a predetermined period of time. For example, the calculation method may multiply the delivery distance, data volume, and predetermined coefficient of efficiency for deliveries that occurred regardless of success or failure during a predetermined period, and then subtract a penalty for the number of non-deliveries therefrom. Calculation conditions are not limited to these and can be defined arbitrarily.

The charging processing apparatus 700 is realized by a general-purpose information processor provided with a CPU, a memory, and a communication interface.

While each example embodiment of the present disclosure has thus been described, the present disclosure is not limited thereto. Further modifications, replacements, and adjustments can be made without departing from a basic technical concept of the present invention. For example, configurations of the networks and configurations of each element illustrated in each drawing have been used only as examples to facilitate understanding of the present disclosure. That is, the present disclosure is not limited to the configurations illustrated in the drawings.

Finally, preferred modes of the present disclosure will be summarized.

The whole or part of each example embodiment and each variation example disclosed above can be described as, but not limited thereto, the following Modes.

### [Mode 1]

(Refer to the moving body according to the first aspect.)

### [Mode 2]

The moving body above preferably further includes an abnormality detecting part that detects the abnormality and notifies the storage control part.

### [Mode 3]

In the moving body above, it is preferable that the input/output part receives from an external apparatus that the abnormality has been detected and notifies the storage control part.

### [Mode 4]

The moving body above preferably further includes an authentication request part that requests the transmission apparatus and the reception apparatus to authenticate the moving body prior to transmitting and receiving the encryption key.

### [Mode 5]

In the moving body above, it is preferable that the input/output part communicates the encryption key with the transmission apparatus and the reception apparatus using a laser beam.

### [Mode 6]

In the moving body above, it is preferable that the input/output part communicates the encryption key with the transmission apparatus and the reception apparatus using a quantum cryptography communication.

### [Mode 7]

In the moving body above, it is preferable that the abnormality includes at least one selected from the group consisting of an abnormal value, an interference of another object with the moving body, data transmission between the moving body and another device, and an abnormality resulting from analysis of log information of the moving body, and the abnormal value is at least one selected from the group consisting of abnormal values of vibration, temperature, voltage, position, movement speed, and movement time of the moving body.

### [Mode 8]

In the moving body above, it is preferable that the moving body is a flying body.

### [Mode 9]

(Refer to the encryption key delivery system according to the second aspect.)

### [Mode 10]

In the encryption key delivery system above, it is preferable that the transmission apparatus further includes a transmission apparatus authentication part that authenticates the moving body, the reception apparatus further includes a reception apparatus authentication part that authenticates the moving body, the transmission apparatus communication part transmits the encryption key to the moving body in a case where the transmission apparatus authentication part succeeds in authentication, and the reception apparatus communication part receives the encryption key from the moving body in a case where the reception apparatus authentication part succeeds in authentication.

### [Mode 11]

The encryption key delivery system above preferably further includes the moving body according to any one of Modes 1 to 8 as a second moving body, and the second moving body preferably receives an encryption key from the transmission apparatus, the encryption key received being the same as the encryption key delivered by the moving body.

### [Mode 12]

The encryption key delivery system above preferably further includes the moving body according to any one of Modes 1 to 8 as a second moving body, and the second moving body preferably receives an encryption key from the transmission apparatus, the encryption key received being different from the encryption key delivered by the moving body.

### [Mode 13]

The encryption key delivery system above preferably further includes a charging processing apparatus that collects parameters related to charging generated by the encryption key delivery system and performs charging.

### [Mode 14]

(Refer to the encryption key delivery method according to the third aspect.)

### [Mode 15]

(Refer to the program according to the fourth aspect.) The Modes 14 and 15 can be expanded in the same manner as Mode 1 is expanded to Modes 2 to 8.

The disclosure of each of above cited PTLs is incorporated herein by reference thereto.

Modifications and adjustments of the example embodiments or examples are possible within the scope of the overall disclosure (including the claims) of the present disclosure and based on the basic technical concept of the present invention.

Various combinations and selections of examples and disclosed elements (including the elements in each of the claims, example embodiments, examples, drawings, etc.) are possible within the scope of the claims of the present disclosure.

That is, the present disclosure includes various variations and modifications that could be made by those skilled in the art according to the overall disclosure including the claims and the technical concept.

Particularly, any numerical ranges disclosed herein should be interpreted that any intermediate values or subranges falling within the disclosed ranges are also concretely disclosed even without specific recital thereof.

### REFERENCE SIGNS LIST

100: transmission apparatus
111: (transmission apparatus) communication part
112: (transmission apparatus) control part
113: (transmission apparatus) authentication part
121: encryption key storage part
122: authentication information storage part
131: CPU
132: storage device
133: communication device
140: encryption key table
141: authentication information recording part
142: encryption key recording part
150: second encryption key table
151: encryption key recording part
152: reception apparatus ID recording part
200: reception apparatus
211: (reception apparatus) communication part
212: (reception apparatus) control part
213: (reception apparatus) authentication part
221: encryption key storage part
222: authentication information storage part
231: CPU
232: storage device
233: communication device
300: flying body
311: input/output part
312: storage control part
313: abnormality detecting part
314: authentication request part
315: movement control part
321: encryption key storage part
322: authentication information storage part
323: log information storage part
331: CPU
332: storage device
333: communication device
334: sensor
335: navigation device
400: monitor apparatus
411: communication part
412: information acquisition part
413: abnormality detection part
431: CPU
432: storage device
433: communication device
434: information collection device
500: encryption key
600: log information
700: charging processing apparatus
910: encryption key delivery system
920: encryption key delivery system
940: encryption key delivery system
960: encryption key delivery system
970: encryption key delivery system

What is claimed is:

1. A moving body, comprising:
at least a processor; and
a memory in circuit communication with the processor,
wherein the processor is configured to execute program instructions stored in the memory to implement:
an input/output part that receives an encryption key from a transmission apparatus and transmits the encryption key to a reception apparatus;
a storage control part that controls storage of the encryption key in a storage part; and
a movement control part that moves the moving body to the reception apparatus after receiving the encryption key from the transmission apparatus, wherein
the storage control part stores the encryption key in the storage part upon receiving the encryption key from the transmission apparatus and erases the encryption key stored in the storage part in a case where an abnormality is detected.

2. The moving body according to claim 1, wherein the processor is configured to execute program instructions stored in the memory to further implement:
an abnormality sensing part that detects the abnormality and notifies the storage control part.

3. The moving body according to claim 1 wherein the input/output part receives from an external apparatus that the abnormality has been detected and notifies the storage control part.

4. The moving body according to claim 1, wherein the processor is configured to execute program instructions stored in the memory to further implement: further comprising:
an authentication request part that requests the transmission apparatus and the reception apparatus to authenticate the moving body prior to transmitting and receiving the encryption key.

5. The moving body according to claim 1, wherein
the input/output part communicates the encryption key with the transmission apparatus and the reception apparatus using a laser beam.

6. The moving body according to claim 1, wherein
the input/output part communicates the encryption key with the transmission apparatus and the reception apparatus using a quantum cryptography communication.

7. The moving body according to claim 1, wherein
the abnormality includes at least one selected from the group consisting of an abnormal value, an interference of another object with the moving body, data transmission between the moving body and another device, and an abnormality resulting from analysis of log information of the moving body, wherein
the abnormal value is at least one selected from the group consisting of abnormal values of vibration, temperature, voltage, position, movement speed, and movement time of the moving body.

8. The moving body according to claim 1, wherein
the moving body is a flying body.

9. An encryption key delivery system, comprising:
a first moving body that is the moving body according to claim 1;
a transmission apparatus; and
a reception apparatus, wherein
the transmission apparatus comprises
at least a processor; and
a memory in circuit communication with the processor,
wherein the processor is configured to execute program instructions stored in the memory to implement:
a transmission apparatus communication part that transmits the encryption key to the moving body, and
the reception apparatus comprises
at least a processor; and
a memory in circuit communication with the processor,
wherein the processor is configured to execute program instructions stored in the memory to implement:
a reception apparatus communication part that receives the encryption key from the moving body.

10. The encryption key delivery system according to claim 9, wherein
the transmission apparatus further comprises a transmission apparatus authentication part that authenticates the moving body,
the reception apparatus further comprises a reception apparatus authentication part that authenticates the moving body,
the transmission apparatus communication part transmits the encryption key to the moving body in a case where the transmission apparatus authentication part succeeds in authentication, and
the reception apparatus communication part receives the encryption key from the moving body in a case where the reception apparatus authentication part succeeds in authentication.

11. The encryption key delivery system according to claim 9, further comprising:
a second moving body having a same configuration as the first moving body; wherein
the second moving body receives an encryption key from the transmission apparatus, the encryption key received being the same as the encryption key delivered by the first moving body.

12. The encryption key delivery system according to claim 9, further comprising:
a second moving body having a same configuration as the first moving body; wherein
the second moving body receives an encryption key from the transmission apparatus, the encryption key received being different from the encryption key delivered by the first moving body.

13. The encryption key delivery system according to claim 9, further comprising:
a charging processing apparatus that comprises
at least a processor; and
a memory in circuit communication with the processor,
wherein the processor is configured to:
collect parameters related to charging generated by the encryption key delivery system and performs charging.

14. An encryption key delivery method executed by a computer loaded on a moving body, the encryption key delivery method, comprising:
receiving an encryption key from a transmission apparatus;
storing the encryption key received in a storage part;
moving the moving body toward a reception apparatus after storing the encryption key;
erasing the encryption key stored in the storage part in a case where an abnormality of the moving body is detected during a movement; and
transmitting the encryption key stored in the storage part to the reception apparatus, upon arriving at a destination area.

15. A non-transitory computer-readable medium storing a program causing a computer loaded on a moving body to execute;
receiving an encryption key from a transmission apparatus;
storing the encryption key received in a storage part;
moving the moving body toward a reception apparatus after storing the encryption key;
erasing the encryption key stored in the storage part in a case where an abnormality of the moving body is detected during a movement; and
transmitting the encryption key stored in the storage part to the reception apparatus, upon arriving at a destination area.

16. The encryption key delivery method according to claim 14, further comprising:
receiving from an external apparatus that the abnormality has been detected and notifying.

17. The encryption key delivery method according to claim 14, further comprising:
requesting the transmission apparatus to authenticate the moving body prior to transmitting the encryption key, and
requesting the reception apparatus to authenticate the moving body prior to receiving the encryption key, upon arriving at the destination area.

18. The encryption key delivery method according to claim 14, wherein
a reception of the encryption key from the transmission apparatus and a transmission of the encryption key to the transmission apparatus are performed using a laser beam.

19. The encryption key delivery method according to claim 14, wherein
a reception of the encryption key from the transmission apparatus and a transmission of the encryption key to the transmission apparatus are performed using a quantum cryptography communication.

20. The encryption key delivery method according to claim 14, wherein
the abnormality includes at least one selected from the group consisting of an abnormal value, an interference of another object with the moving body, data transmission between the moving body and another device, and an abnormality resulting from analysis of log information of the moving body, wherein
the abnormal value is at least one selected from the group consisting of abnormal values of vibration, temperature, voltage, position, movement speed, and movement time of the moving body.
